(19) United States
(12) Patent Application Publication
(10) Pub. No.: US 2023/0161101 A1
(43) Pub. Date: May 25, 2023

(54) DEVICES AND METHODS EXPLOITING WAVEGUIDE SUPERCELLS

(71) Applicant: UNIVERSITÉ LAVAL, QUÉBEC (CA)

(72) Inventors: WEI SHI, QUÉBEC (CA); QI HAN, QUÉBEC (CA)

(21) Appl. No.: 17/996,895

(22) PCT Filed: Apr. 12, 2021
(86) PCT No.: PCT/CA2021/050484

§ 371 Date: Oct. 21, 2022

Related U.S. Application Data
(60) Provisional application No. 63/015,841, filed on Apr. 27, 2020.

(51) Int. Cl. G02B 6/12

(52) U.S. Cl. CPC G02B 6/12011; G02B 6/12014; G02B 2006/12164; G02B 2006/12159

(57) ABSTRACT

Arrayed waveguide gratings (AWGs) are important components in coarse wavelength divisional multiplexing (CWDM) and dense wavelength division multiplexing (DWDM). However, the waveguides forming the array must be separated by a distance large enough to suppress parasitic coupling between the adjacent waveguides and thus limiting reductions in device footprint and insertion loss between the input/output coupler regions and the central region comprising the arrayed waveguides. The inventors have established a design methodology allowing the waveguide separation to be reduced whilst limiting cross-coupling thereby allowing for reduced footprints and insertion loss.

### CROSS-REFERENCE TO RELATED APPLICATIONS

This application claims the benefit of priority as a 371 National Phase Entry Application of World Intellectual Property Organization Patent Application PCT/CA2021/050484 filed Apr. 12, 2021; which itself claims the benefit of priority from U.S. Provisional Patent Application 63/015,841 filed Apr. 27, 2020; the entire contents of each being incorporated herein by reference.

### FIELD OF THE INVENTION

This invention is directed to photonic waveguide devices and more particularly to parasitic coupling reduction and footprint reduction within such photonic waveguide devices through the use of waveguide supercells.

### BACKGROUND OF THE INVENTION

Arrayed waveguide gratings (AWGs) are important components in coarse wavelength divisional multiplexing (CWDM) and dense wavelength division multiplexing (DWDM) systems to increase the transmission capacity in optical communications by multiplexing or demultiplexing multiple optical wavelengths onto the same optical fiber. AWGs can also be used as spectroscopic sensors, optical add-drop multiplexers, optical routers, wavelength filters, and colorless filters. Accordingly, to data AWGs have been implemented in different material systems, including but not limited, silica-on-silicon (Si), silica-on-insulator (SOI), indium phosphide (InP), gallium arsenide (GaAs), polymer, and glass.

AWGs implemented in silica-on-Si are widely used in commercial telecommunication systems due to their high performance. However, the minimum practical bend radius is large with this type of waveguide which results in devices with significant footprints, where typical die footprints can be 50-80 mm long by 20-30 mm wide and even compact silica-on-Si AWGs reported in the prior art are 20-30 mm long by 5-10 mm wide. In contrast, SOI with a higher refractive index contrast allows the use of smaller radius waveguide bends allowing significant reduction in the AWG footprint. However, such SOI AWGs reported within the prior art are sensitive to fabrication variations which result in phase errors between the arrayed waveguides leading to degraded channel crosstalk performance.

In contrast, silicon nitride (SiN) waveguides offer a promising platform for the realization of high performance AWGs. As SiN waveguides have a lower refractive index contrast than SOI waveguides they provide improved tolerance to fabrication errors when compared to SOI and crosstalk is generally lower in SiN AWGs than in SOI AWGs. However, with conventional AWG designs, the waveguides forming the array must be separated by a distance large enough to suppress parasitic coupling between the adjacent waveguides and thus minimize waveguide crosstalk. The inventors, for example, previously established that a large 10 μm gap was necessary to reduce the waveguide crosstalk to an acceptable level. This waveguide separation thereby limits optimization of the AWG footprint and contributes to insertion loss due to the low coupling efficiency between the input/output coupler regions and the central region comprising the arrayed waveguides.

Accordingly, it would be beneficial to provide photonic circuit designers with a methodology allowing the waveguide separation to be reduced whilst limiting the cross-coupling between adjacent waveguides with the array waveguide portion of the AWG, thereby reducing waveguide crosstalk, and reducing channel crosstalk. It would be further beneficial for these techniques for limiting cross-coupling between adjacent waveguides to be compatible with other photonic waveguide circuits topologies and components such that cross-coupling can be limited in any photonic circuit where two or more waveguides must run parallel to one another for significant distances.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to photonic waveguide devices and more particularly to parasitic coupling reduction and footprint reduction within such photonic waveguide devices through the use of waveguide supercells.

In accordance with an embodiment of the invention there is provided a waveguide device comprising:
an input waveguide coupled to a first end of a first free propagation region (FPR);
an array of waveguide supercells each comprising a plurality of waveguides, each waveguide of the plurality of waveguides having a different target effective refractive index to each other waveguide within the plurality of waveguides, coupled at a first end to a first predetermined position on a second distal end of the first FPR and coupled at a second distal end to a second predetermined position of a first end of a second FPR; and
a plurality of output waveguides, each output waveguide of the plurality of output waveguides coupled to a third predetermined position on a second distal end of the second FPR.

In accordance with an embodiment of the invention there is provided a method of improving channel crosstalk performance of an array waveguide grating (AWG) device comprising:
providing an input waveguide coupled to a first end of a first free propagation region (FPR);
providing an array of waveguide supercells each comprising a plurality of waveguides, each waveguide of the plurality of waveguides having a different target effective refractive index to each other waveguide within the plurality of waveguides, coupled at a first end to a first predetermined position on a second distal end of the first FPR and coupled at a second distal end to a second predetermined position of a first end of a second FPR; and
providing a plurality of output waveguides, each output waveguide of the plurality of output waveguides coupled to a third predetermined position on a second distal end of the second FPR.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a schematic of an array waveguide grating (AWG);

FIG. 2A depicts a schematic of an AWG according to an embodiment of the invention;

FIG. 2B depicts the input free propagation region (FPR or input coupler region) of an AWG according to an embodiment of the invention;

FIG. 2C depicts a detailed view of the transition between the input FPR comprising a planar (2D) waveguide and the arrayed waveguide region comprising a plurality of channel (3D) waveguides for an AWG according to an embodiment of the invention;

FIG. 3 depicts schematically the concept of a waveguide supercell as exploited within embodiments of the invention;

FIG. 4A depicts the suppression of optical coupling within a waveguide supercell according to an embodiment of the invention exploiting a narrow waveguide gap;

FIG. 4B depicts the optical coupling within prior art waveguides at the same separation as that employed within FIG. 4A;

FIG. 4C depicts the results of a simulation of field distribution within a waveguide supercell according to an embodiment of the invention exploiting a narrow waveguide gap;

FIG. 4D depicts the results of a simulation of field distribution within prior art waveguides at the same separation as that employed within FIGS. 4A and 4C;

FIG. 5A depicts schematically the output FPR (output coupler region) of an AWG according to an embodiment of the invention;

FIG. 5B depicts schematically an array waveguide supercell according to an embodiment of the invention;

FIG. 5C depicts schematically a traditional array waveguide structure at the same separation as that employed within FIG. 5B;

FIG. 6A depicts schematically an 8 channel 100 GHz waveguide supercell AWG (AWG-SC) according to an embodiment of the invention;

FIG. 6B depicts a scanning electron microscope (SEM) image of an optical micrograph of a fabricated SiN 8 channel 100 GHz AWG with waveguide supercell (AWG-SC) according to an embodiment of the invention;

FIG. 6C depicts an SEM image of a fabricated SiN 8 channel 100 GHz AWG employing prior art arrayed waveguides at the same separation as the AWG-SC in FIG. 6B;

FIG. 7A depicts an SEM image of a cross-section of a fabricated waveguide supercell as employed within the AWG-SC of FIG. 6B;

FIGS. 7B and 7C depict SEM images of the two different width waveguides employed within the exemplary waveguide supercell according to an embodiment of the invention for the AWG-SC of FIG. 6B;

FIG. 8A depicts the measured spectrum of a Mach-Zehnder interferometer (MZI) test structure employing a pair of waveguides as depicted in FIG. 5C as employed in prior art AWGs at the same spacing as the waveguide supercell;

FIG. 8B depicts the measured spectrum of a Mach-Zehnder interferometer (MZI) test structure employing a pair of waveguides forming the waveguide supercell as depicted in FIG. 5B employed within the AWG-SC of FIG. 6B;

FIG. 9A depicts the measured spectrum of an AWG-SC as depicted in FIG. 6B employing the waveguide supercell as depicted in FIG. 5B;

FIG. 9B depicts the measured spectrum of an AWG as depicted in FIG. 6C employing prior art arrayed waveguides as depicted in FIG. 5C at the same separation as the AWG-SC in FIG. 6B;

FIG. 9C depicts the measured spectrum of an AWG-SC as depicted in FIG. 6B employing the waveguide supercell as depicted in FIG. 5B;

FIG. 9D depicts the measured spectrum of an AWG as depicted in FIG. 6C employing prior art arrayed waveguides as depicted in FIG. 5C at the same separation as the AWG-SC in FIG. 6B;

FIG. 10 depicts a schematic of an AWG-SC according to an embodiment of the invention exploiting a multimode interference (MMI) structure between the input channel waveguide and the input free propagation region (FPR);

FIG. 11 depicts a schematic of an AWG-SC according to an embodiment of the invention exploiting a 2×2 multimode interference (MMI) structure between the input channel waveguide and the input FPR for polarization splitting the input signal and launching TE/TM polarizations at different points into the input FPR;

FIG. 12 depicts an AWG-SC according to an embodiment of the invention exploiting a 2×2 multimode interference (MMI) structure between the input channel waveguide and the input FPR for polarization and MMI structures between the output FPR and the output waveguides;

FIG. 13 depicts schematically a dual AWG-SC optical system for providing polarization diverse wavelength division demultiplexing;

FIG. 14 depicts schematically a dual AWG-SC optical system such as depicted in FIG. 13 with the addition of polarization combiners;

FIG. 15 depicts schematically an exemplary configuration of waveguides within an AWG-SC according to an embodiment of the invention;

FIG. 16 depicts schematically an exemplary configuration of waveguides within an AWG-SC according to an embodiment of the invention with single tapers; and

FIG. 17 depicts schematically an exemplary configuration of waveguides within an AWG-SC according to an embodiment of the invention with multiple tapers.

### DETAILED DESCRIPTION

The present invention is directed to photonic waveguide devices and more particularly to parasitic coupling reduction and footprint reduction within such photonic waveguide devices through the use of waveguide supercells.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It would be understood by one of skill in the art that various changes can be made in the function and arrangement of elements without departing from the scope of the invention as set forth in the claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional elements.

A “two-dimensional” waveguide, also referred to as a 2D waveguide or a planar waveguide, as used herein may refer to, but is not limited to, an optical waveguide supporting propagation of optical signals within a predetermined wavelength range which does not guide the optical signals laterally relative to the propagation direction of the optical signals.

A “three-dimensional” waveguide, also referred to as a 3D waveguide or a channel waveguide, as used herein may refer to, but is not limited to, an optical waveguide supporting propagation of optical signals within a predetermined wavelength range which guides the optical signals laterally relative to the propagation direction of the optical signals.

A “wavelength division multiplexer” (WDM MUX or MUX) as used herein may refer to, but is not limited to, an optical device for combining (multiplexing) multiple optical signals of different wavelengths together onto a common optical waveguide, e.g. a waveguide forming part of a photonic integrated circuit or an optical fiber. For example, such a MUX may exploit an array waveguide grating (AWG) wherein N input ports each carrying optical signals at a different predetermined wavelength are combined to a single output port.

A “wavelength division demultiplexer” (WDM DMUX or DMUX) as used herein may refer to, but is not limited to, an optical device for splitting (demultiplexing) multiple optical signals of different wavelengths apart which are received on a common optical waveguide, e.g. a waveguide forming part of a photonic integrated circuit or an optical fiber. For example, such a DMUX may exploit an array waveguide grating (AWG) wherein a single input port carrying optical signals is split into N outputs each carrying optical signals at a different predetermined wavelength.

An “optical router” as used herein may refer to, but is not limited to, an optical device comprising a plurality of input ports and a plurality of output ports wherein optical signals at an input are routed to an output in dependence upon their wavelength. For example, such an optical router may exploit an array waveguide grating (AWG) comprising N input ports and M output ports wherein each input port of the N input ports carries optical signals at predetermined wavelengths which are coupled to outputs ports of the M output ports in dependence upon their wavelength and which input port they are coupled to.

“Waveguide crosstalk” as used herein refers to, but is not limited to, optical cross-coupling between adjacent and non-adjacent optical waveguides.

“Channel crosstalk” as used herein refers to the total accumulated optical crosstalk within an optical channel of a wavelength division demultiplexer (DMUX), e.g. an array waveguide grating (AWG) DMUX, arising from all sources including, but not limited to, crosstalk and phase noise within the AWG.

Within the embodiments of the invention described below the optical waveguides exploit a silicon nitride core with silicon oxide upper and lower cladding, a SiO₂—Si₃N₄—SiO₂ waveguide structure. However, it would be evident that embodiments of the invention may also be employed in conjunction with other waveguide materials systems. These may include, but not be limited to:
a silicon core and silicon nitride upper and lower claddings, a Si₃N₄—Si—Si₃N₄ waveguide structure;
a silicon core with silicon oxide upper and lower claddings, a SOI waveguide, e.g. SiO₂—Si—SiO₂;
a doped silica core relative to undoped cladding, a SiO₂-doped _SiO₂—SiO₂, e.g. germanium doped (Ge) yielding SiO₂—Ge:SiO₂—SiO₂;
a silicon core and silicon oxynitride upper and lower claddings, a SiO_{X}N_{Y}—Si—SiO_{X}N_{Y} waveguide structure;
silicon oxynitride core with silicon oxide upper and lower claddings, a SiO₂—SiO_{X}N_{Y}—SiO₂ waveguide structure;
polymer-on-silicon; and
doped silicon waveguides.

Additionally, waveguide structures without upper claddings may be employed. However, it would be evident to one skilled in the art that the embodiments of the invention may be employed in a variety of waveguide coupling structures coupling onto and/or from waveguides employing material systems that include, but not limited to, SiO₂—Si₃N₄— SiO₂; SiO₂— Ge:SiO₂—SiO₂; Si—SiO₂; ion exchanged glass, ion implanted glass, polymeric waveguides, indium gallium arsenide phosphide (InGaAsP), InP, GaAs, III-V materials, II-VI materials, Si, SiGe, and multi-core optical fiber.

Further, whilst the embodiments of the invention are described and depicted with respect to a waveguide employing a core embedded within cladding, a so-called buried waveguide, it would be evident that other waveguide geometries such as rib waveguide, diffused waveguide, ridge or wire waveguide, strip-loaded waveguide, slot waveguide, and anti-resonant reflecting optical waveguide (ARROW waveguide), photonic crystal waveguide, suspended waveguide, alternating layer stack geometries, sub-wavelength grating (SWG) waveguides and augmented waveguides (e.g. Si—SiO₂—Polymer). Further, whilst the embodiments of the invention are described and depicted with respect to a step-index waveguide it would be evident that other waveguide geometries such as graded index and hybrid index (combining inverse-step index and graded index) may be employed.

Whilst embodiments of the invention are described and depicted with respect to passive channel (3D) waveguides within array waveguide gratings (AWGs) it would be evident that the waveguide supercell methodologies described and depicted may be employed within other passive waveguide structures including, but not limited to, Mach-Zehnder interferometers, arrays of Bragg gratings (see for example Menard et al. in WO/2015/131270 entitled “Methods and Systems for Wavelength Tunable Optical Components and Sub-Systems”), optical time delay devices (see for example U.S. Pat. No. 5,852,687 “Integrated Optical Time Delay Unit” and Yegnanarayanan et al. in “Compact Silicon Based Integrated Optical Time Delays” (IEEE Phot. Tech. Lett. Vol. 9, No. 5, pp. 634-535)), optical ring resonators (see for example Tran et al. in “Ultra-Low-Loss Silicon Waveguides for Heterogeneously Integrated Silicon/III-V Photonics” (Applied Sciences, Vol. 8, 1139, pp. 1-13)), optical sensors and monolithically integrated optical sensors (see for example Antoine et al. in “Design of Slow-Light Subwavelength Grating Waveguides for Enhanced On-Chip Methane Sensing by Absorption Spectroscopy” (IEEE Journal of Selected Topics in Quantum Electronics, VOL. 25, NO. 3. pp. 5200308)) and optical beam steerers (see for example Van Acoleyen et al. in “Off-Chip Beam Steering with a One-Dimensional Phased Array on Silicon-on-Insulator” (Optics Letters, Vol. 34, No. 9, pp. 1477-1479)).

Whilst embodiments of the invention are described and depicted with respect to passive channel (3D) waveguides within array waveguide gratings (AWGs) it would be evident that the waveguide supercell methodologies described and depicted may be employed within active waveguide structures including, but not limited to, Mach-Zehnder interferometers, optical beam steerers (see for example Doylend et al. in “Two-Dimensional Free-Space Beam Steering with an Optical Phased Array on Silicon-on-Insulator” (Optics Express, Vol. 19, No. 22, 21595)), dynamic dispersion compensating AWGs, arbitrary filters (see for example Fontaine et al. in “Active Arrayed-Waveguide Grating with Amplitude and Phase Control for Arbitrary Filter Generation and High-Order Dispersion Compensation” (IEEE European Conference on Optical Communication 2008. Paper Mo.4.C.3)), and waveguide arrays (see for example Ma et al. in “High-Resolution Compact On-Chip Spectrometer Based on an Echelle Grating with Densely Packed Waveguide Array” (IEEE Photonics Journal, Vol. 11, No. 1, 4900107)).

As noted above within prior art AWGs the requirement for low waveguide crosstalk between adjacent waveguides results in a large waveguide separation within the central phased array portion of the AWG, thereby resulting in large footprint devices which impacts a variety of factors including, but not limited to, insertion loss, integration of other passive and active waveguide elements, cost, and packaging complexity. Accordingly, it would be beneficial to exploit one or more methodologies which reduce the optical cross-coupling between waveguides as their separation is reduced thereby reducing this waveguide crosstalk. Beneficially, reducing the overall footprint of the AWG also reduces other aspects such as phase noise thereby yielding improved channel crosstalk performance for the AWG.

Accordingly, the inventors exploit the concept of a waveguide supercells wherein both the coupling between waveguides within each waveguide supercell is reduced (referred to by the inventors as intra-coupling) and the coupling between waveguides within adjacent waveguide supercells is reduced (referred to by the inventors as inter-coupling).

Referring to FIG. 1 there is depicted an exemplary schematic 100 of an AWG providing a wavelength division demultiplexer (DMUX) functionality. Such an AWG geometry may be implemented, for example, using silica-based optical waveguides such as SiO₂—Ge:SiO₂—SiO₂. As depicted an input waveguide 110 couples to a first free propagating region (FPR, also known as a planar or 2D waveguide) 120. Accordingly, the optical signal from the input waveguide form an optical wavefront which couples to the array of waveguides 130 which start at the other end of the first FPR 120 to the input waveguide 110 and end at the second FPR 140. The array of waveguides having an initial separation d1 where they couple to the first FPR 120, a separation d2 the mid-point of the AWG 100, and final separation d3 where they couple to the second FPR 140. The multiple optical signals from the array of waveguides 130 coupled to the second FPR 140 combine according to accumulated phase shifts to a waveguide of an output array 150 at the other end of the second FPR 140. As the accumulated phase shifts vary with wavelength then different wavelengths have different combination positions such that different waveguides in the output array 150 couple different wavelengths. The incremental path length between adjacent waveguides Lᵢ and Lᵢ₊₁ within the array of waveguides 130 is given by Equation (1) below where λ_{c} is the centre wavelength of the AWG 100, m the order of the grating, and n_{eff} the effective refractive index of the optical waveguides within the array of waveguides 130.

$$Δ L = {L}_{i + 1} - {L}_{i} = \frac{m {λ}_{c}}{{n}_{e f f}} \qquad ( 1 )$$

It would be evident that if optical signals are now coupled to the output array 150 then these optical signals will propagate and combine at the other end of the AWG 100 such that it now acts as a wavelength division multiplexer (MUX).

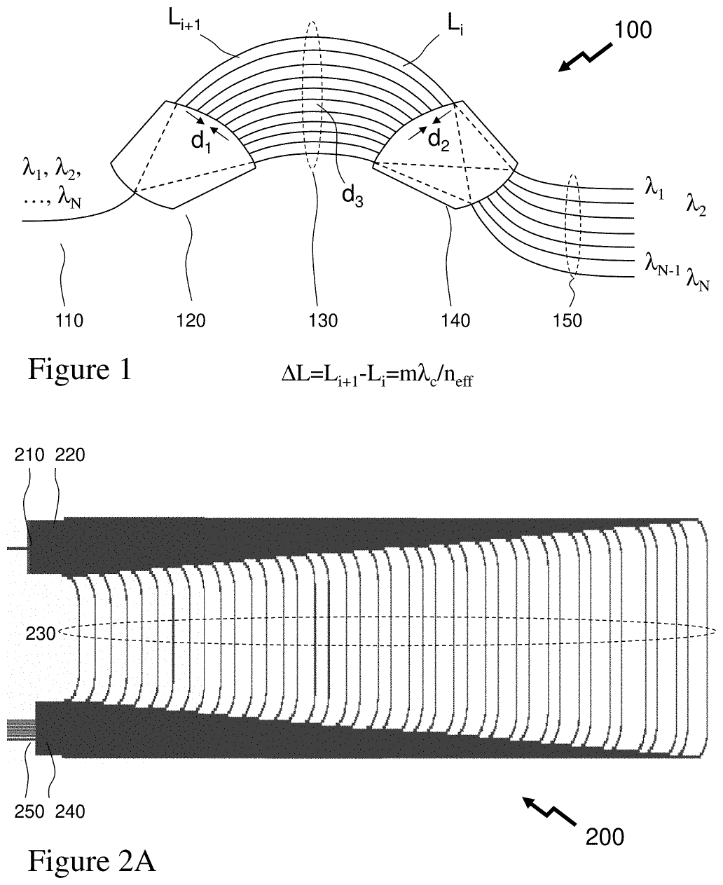

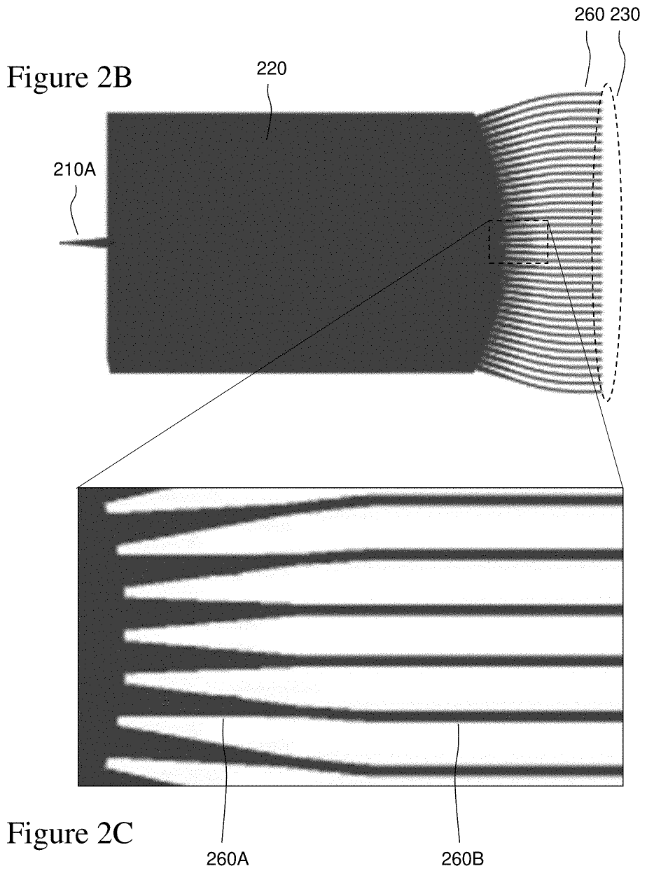

Now referring to FIG. 2A there is depicted an exemplary schematic 200 of an AWG employing silicon nitride based optical waveguides such as SiO₂—Si₃N₄—SiO₂ wherein smaller radius waveguide bends can be employed due to the higher refractive index contrast between the waveguide core (Si₃N₄) and cladding (SiO₂). Accordingly, there is depicted an input waveguide 210, first FPR 220, array of waveguides 230, second FPR 240 and output waveguide array 250. Within the subsequent exemplary implementations described below the array of waveguides 230 comprises 40 channel waveguides for the 8 channel 100 GHz AWGs although it would be evident to one of skill in the art that different numbers of waveguides may be implemented within the array of waveguides which may be varied in dependence upon one or more factors including for example, channel count, channel spacing, and free spectral range (FSR). Referring to FIG. 2B there is depicted schematically the first FPR 220 together with a tapered section 210A of the input waveguide as it couples to the first FPR 220. At the other end of the first FPR 220 there are depicted channel waveguides 260 which form the array of waveguides 230. As evident from FIG. 2C which is a zoomed region of the transition from the first FPR 220 to the array of waveguides 230 wherein each channel waveguide 260 comprises a first tapered portion 260A and a second constant width portion 260B. At the other end, the channel waveguide 260 may comprise a second tapered portion for coupling to the second FPR 240. Optionally, each output waveguide within the output waveguide array 250 may also comprise a taper at the transition to the second FPR 240.

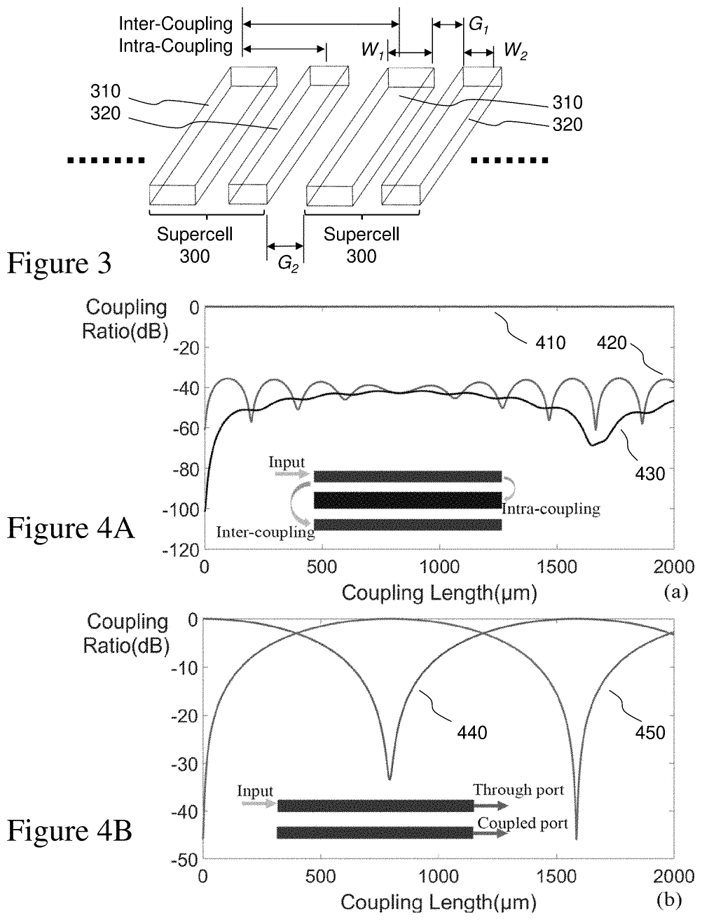

Accordingly, within the prior art the width of each channel waveguide 260 in the second constant width portion 260B is the same. Hence, for extended regions of such parallel nominally identical waveguides optical coupling occurs between each thereby degrading the performance of the AWG. The inventors thereby introduce the concept of waveguide supercells such as an embodiment of waveguide supercells as depicted in FIG. 3. As depicted a pair of waveguide supercells 300 are depicted each comprising a first waveguide 310 of width w₁ and a second waveguide 320 of width w₂ separated from the first waveguide 310 by a waveguide gap G₁ between the inner edges of the first and second waveguides 310 and 320 respectively although the concept of waveguide supercells may be extended to 3, 4, or more waveguides within each waveguide supercell. The adjacent waveguide edges of each waveguide supercell 300 being separated as depicted by a supercell gap of G₂.

It is known that the normalized power coupling, waveguide crosstalk, from one waveguide to another waveguide within a pair of waveguides is determined by Equation (2) where P₂ represents the power in the second waveguide coupled from the first waveguide with initial power P₁, Δβ represents the propagation constant difference between the pair of waveguides, κ represents the coupling strength, and L represents the propagation distance over which the pair of waveguides are coupled. Within the prior art using silica-based optical waveguides, such as SiO₂—Ge:SiO₂—SiO₂ for example, of equal width (i.e. w₁=w₂) then reduction of optical coupling relied upon reducing the coupling strength K by separating the waveguides sufficient far apart. However, if the width of the pair of waveguides are different such that the effective indices of the two waveguides are now different then such that waveguide crosstalk can be reduced to the same levels achieved with large waveguide separations for identical width waveguides with higher coupling strengths arising from reduced waveguide separation. Generally, this is reduced to the assumption that if the phase mismatch is large relative to the coupling strength (i.e. Δβ>>κ) then the coupling will be low and hence the waveguide crosstalk low. Hence, waveguide crosstalk between waveguides within the AWG array will be lower, which in turn, will contribute to improved channel crosstalk performance for the AWG.

$$\frac{{P}_{2}}{{P}_{1}} = \frac{1}{{( Δβ / 2 κ )}^{2} + 1} \cdot {sin}^{2} ( \sqrt{{( Δβ / 2 )}^{2} + {κ}^{2}} L ) \qquad ( 2 )$$

Accordingly, with reference to a waveguide supercell 300 in FIG. 3 then the use of a pair of waveguides with different widths allows the waveguide separation to be significantly reduced such that little to no parasitic coupling occurs between the pair of waveguides within each waveguide supercell. Accordingly, in the embodiment of the invention as depicted within FIG. 3 the phase mismatch to suppress optical coupling arises from the effective index difference due to the difference in width between waveguides within the waveguide supercell. This being referred to as intra-waveguide supercell coupling (or intra-coupling) by the inventors.

However, it is also a design consideration to consider optical coupling between the waveguides with identical widths in adjacent waveguides supercells since waveguide crosstalk can occur between the nearest and next-nearest waveguides within a waveguide array such as the array of waveguides within the central portion of the AWG, e.g. array of waveguides 130 in FIG. 1 and array of waveguides 230 in FIG. 2A. This being referred to as inter-waveguide supercell coupling (inter-coupling by the inventors). Hence, coupling between the waveguides of width w₁ in adjacent waveguide supercells should be considered as well as the coupling between the waveguides of width w₂ in adjacent waveguide supercells. The coupling between the adjacent waveguides of widths w₁ and w₂ being suppressed in the same manner as that within a single waveguide supercell.

Although analysis of waveguide crosstalk between a pair of waveguides is relatively straight forward to analyse using Equation (2) the scaling up of this to offer a crosstalk solution for a large array of waveguides does not easily converge to a single solution. Accordingly, the inventors decision within the embodiments of the invention presented below to use supercells comprising two waveguides per supercell for which a solution convergent upon a set of design parameters can be established according to Equation (2). For example, the two waveguides of width w₁ between adjacent waveguide supercells cannot be modelled easily using Equation (2) as the intervening intermediate waveguide of w₂ adjusts the coupling. Accordingly, the waveguides within each waveguide supercell and the array of waveguide supercells create multiple options for inter-coupling and intra-coupling. For example, a design methodology may be implemented with a first process establishing waveguide crosstalk below a target level within a waveguide supercell and then a second process establishing waveguide crosstalk below the target level between the multiple waveguide combinations within adjacent supercells. In some instances, a third process may be required to consider large waveguide supercell groupings.

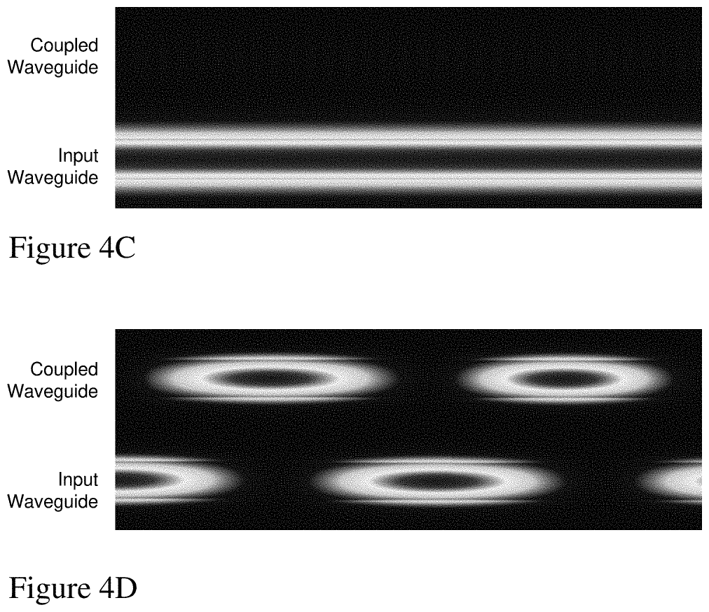

In order to calculate the coupling ratio within and between waveguide supercells the inventors employed an Eigenmode Expansion (EME) solver solution. This being selected as the computational cost of the method scales exceptionally well with the device length, making it more efficient for the design and optimization of long devices compared to other finite difference time domain (FDTD) based methods. Accordingly, the inventors chose as a result of this analysis an initial waveguide supercell comprising a first waveguide of width 800 nm and a second waveguide of width 900 nm. The gap between these waveguides being adjacent waveguides 1.5 μm within the waveguide supercell. Accordingly, within FIG. 4A there are plotted the simulated results for the Through Port 410, the Inter-Coupling 420 and the Intra-Coupling 430. As evident from FIG. 4A the coupling ratio is quite low (˜−40 dB) between the adjacent waveguides (intra-coupling) within a single waveguide supercell. Further, the coupling ratio between identical waveguides across adjacent waveguide supercells (inter-coupling) was similar to that of intra-coupling (˜−40 dB).

By comparison, a reference design comprising a pair of identical 800 nm waveguides with a gap of 1.5 μm was also modelled, the results of which are depicted in FIG. 4B wherein the simulated results show the Through Port 440 and Coupled Port 450. The cross-coupling clearly exceeds acceptable levels. In fact, complete coupling between the waveguides occurs with a coupling length of approximately 800 μm.

In order to observe how alternating the waveguide widths decrease parasitic coupling the field distributions for the two structures were plotted. Accordingly, the waveguide supercell with 800 nm and 900 nm waveguides at 1.5 μm separation is plotted in FIG. 4C whilst the prior art pair of 800 nm waveguide at the same 1.5 μm is plotted in FIG. 4D. Accordingly, it is evident that a reduction in parasitic coupling between adjacent waveguides occurs within the waveguide supercell. Accordingly, it is evident that waveguide supercells can effectively suppress the parasitic coupling between waveguide supercells and thus improve the channel crosstalk performance of the AWG.

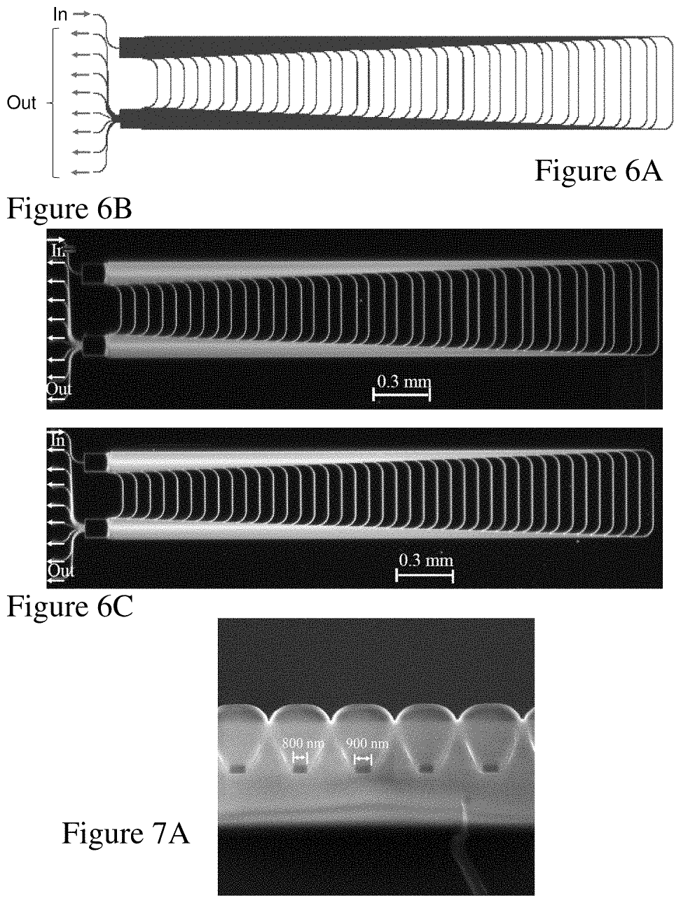

In order to demonstrate the performance improvement facilitated by the proposed waveguide supercell structure the inventors designed and fabricated two 1×8 AWGs. The first was a conventional design using an array of waveguides of identical width and the second exploited the waveguide supercell design. FIG. 6A depicts a schematic of the AWG design exploiting the waveguide supercell having a footprint comprising the pair of FPRs and waveguide array of 4.3 mm by 0.6 mm. As described above the waveguides in the array are designed with a length difference ΔL between adjacent identical waveguides. Thus, the array has a path length difference between each successive waveguide as given by Equation (3) where m is the grating order, λ_{c} is the center wavelength, and n_{eff} (w₁) and n_{eff} (w₂) are the effective indexes of the waveguides with widths w₁ (800 nm) and w₂ (900 nm) respectively. Accordingly, the length difference between adjacent w₁ (800 nm) waveguides is presented by ΔL_{w1} and ΔL_{w2} is the length difference between adjacent w₂ (900 nm) waveguides. The design waveguide thickness for the Si₃N₄ core of the SiO₂—Si₃N₄—SiO₂ waveguides being 440 nm. The waveguide widths were chosen as a result of the necessary comprise between considerations such as tolerance to fabrication errors (the wider the better in general), parasitic coupling, and single mode operation. Beyond 900 nm in width, the 440 nm thick SiO₂—Si₃N₄—SiO₂ waveguides tend to support higher-order modes.

mλ_{c}=n_{eff}(w₁)ΔL_{w1}=n_{eff}(w₂)ΔL_{w2} (3)

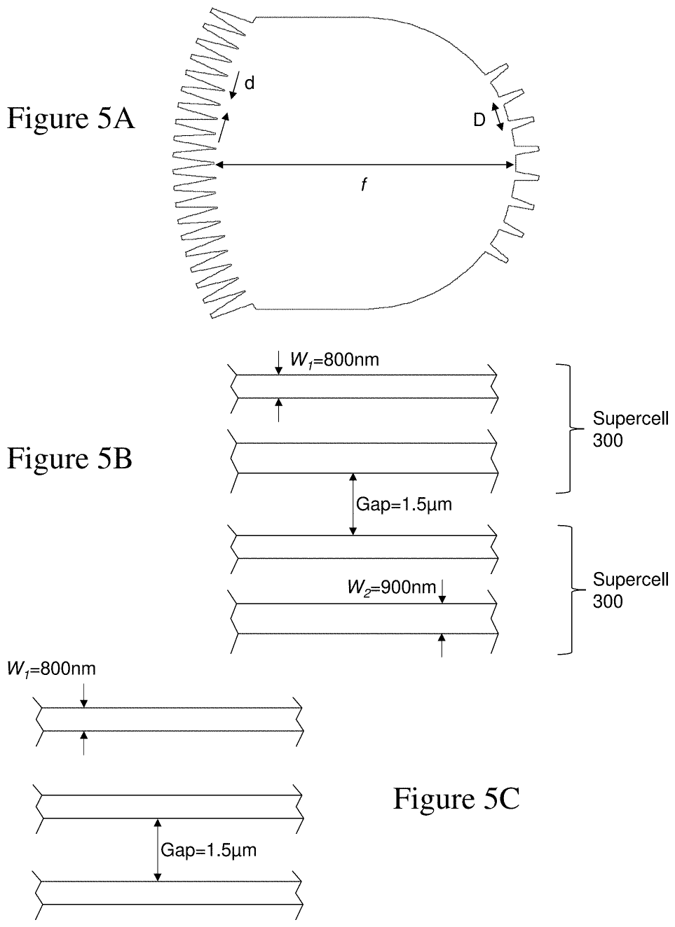

Another aspect of the design is the grating order m which is determined by the design of the output FPR coupler and the arrayed waveguides. A schematic of the output star coupler is shown in FIG. 5A wherein the length of the output FPR is f, the separation between sequential arrayed waveguides at one end of the output FPR is d, the separation between sequential output waveguides at the other end of the output FPR is D. Accordingly, the grating order m is given by Equation (4) where nₛ is the effective index of the FPR (a planar of 2D waveguide region) and Δλ is the channel spacing of the AWG, e.g. 200 GHz (˜1.6 nm at 1550 nm), 100 GHz (˜0.8 nm at 1550 nm), 50 GHz (˜0.4 nm at 1550 nm) for DWDM telecommunications or 20 nm (CWDM).

$$m = \frac{D \cdot d \cdot {n}_{s}}{f \cdot Δλ} \qquad ( 4 )$$

However, despite the effective indexes between two waveguides of the waveguide supercell that are 800 nm and 900 nm wide being different, i.e. n_{eff} (w₁)≠n_{eff} (w₂), they must have the same grating order as defined by Equation (4). Accordingly, the length difference between the adjacent waveguides of the waveguide supercell must be designed with different value (ΔL_{w1}≠ΔL_{w2}). As such, the optimization of length difference is a tradeoff between the footprint and the channel crosstalk. A large length difference for a higher grating order leads to a larger footprint and potentially increased losses. However, with respect to Equation (4) a smaller length difference for a lower grating order requires reduced separation either between the arrayed waveguides and/or between output channels. This may cause greater coupling between adjacent apertures and thus higher level of channel crosstalk with the AWG. It would be evident that these design tradeoffs would not exist for other photonic circuits such as those described above, for example, not relying upon phase difference between adjacent waveguides. Accordingly, within the implemented initial 1×8 100 GHz AWG devices to demonstrate the waveguide supercell concept the length difference was established as 472.56 μm for the adjacent 800 nm wide waveguides (ΔL_{w1}) and 461.31 μm for the adjacent 900 nm wide waveguides (ΔL_{w2}).

For both the reference AWG and the AWG with a waveguide supercell (AWG-SC), an array of 40 waveguides with separations 1.5 μm between adjacent waveguides was employed yielding the structures depicted in FIGS. 5B and 5C respectively. As described above with the waveguide supercell 300, the width of the waveguide alternates between 800 nm and 900 nm (FIG. 5B), whereas in the conventional AWG, all the waveguides have a width of 800 nm (FIG. 5C). Both devices were designed for a nominal center wavelength of 1550 nm and a channel spacing of 100 GHz. Waveguide tapers were employed used to reduce the coupling loss between each FPR and the arrayed waveguides. A large bend radius of 100 μm was used for the waveguide bends in order to minimize waveguide bending losses. Both AWGs having a footprint of 4.3 mm×0.6 mm.

In order to characterize the anti-coupling effect of the waveguide supercell, the inventors also designed a pair of Mach-Zehnder interferometers (MZIs). One had a directional coupler formed from identical 800 nm-wide waveguides whilst the other employed the 800 nm/900 nm waveguide pairing of the waveguide supercell. Both MZIs having a coupling gap of 1.5 μm and a 600 μm length imbalance between the two arms.

The AWGs and MZIs were implemented on a SiO₂—Si₃N₄—SiO₂ waveguide platform with a nominal Si₃N₄ waveguide core thickness of 440 nm. The waveguide fabrication comprising:

Depositing a lower cladding of SiO₂ with a thickness of 3.2 μm upon the Si wafer; Depositing the core of Si₃N₄ to a thickness of 440 nm; Electron beam lithography to define the waveguide patterns; Dry etching to remove unwanted Si₃N₄; Depositing an upper cladding of SiO₂ with a thickness of 3.4 μm to conformally coat the Si₃N₄.

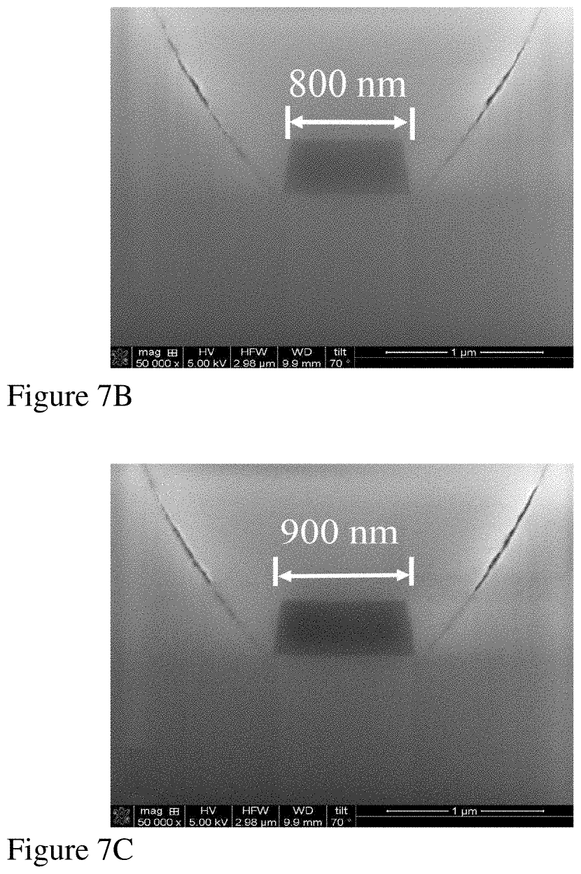

Referring to FIGS. 6B and 6C there are depicted scanning electron microscope (SEM) images of the AWG-SC (using dual waveguide supercells of 800 nm/900 nm waveguides) and reference AWG (using only 800 nm waveguides) respectively. FIG. 7A depicts a cross-sectional SEM through the array of waveguides. Some cracks in the upper SiO₂ cladding are evident on both sides of the waveguides due to exploitation of an unoptimized process of plasma-enhanced chemical vapor deposition (PECVD). These cracks introducing additional excess loss within the fabricated devices but can be removed through an optimization of manufacturing process(es). FIGS. 7B and 7C depicting higher magnification SEM images of the 800 nm and 900 nm waveguides respectively within the AWG-SC device.

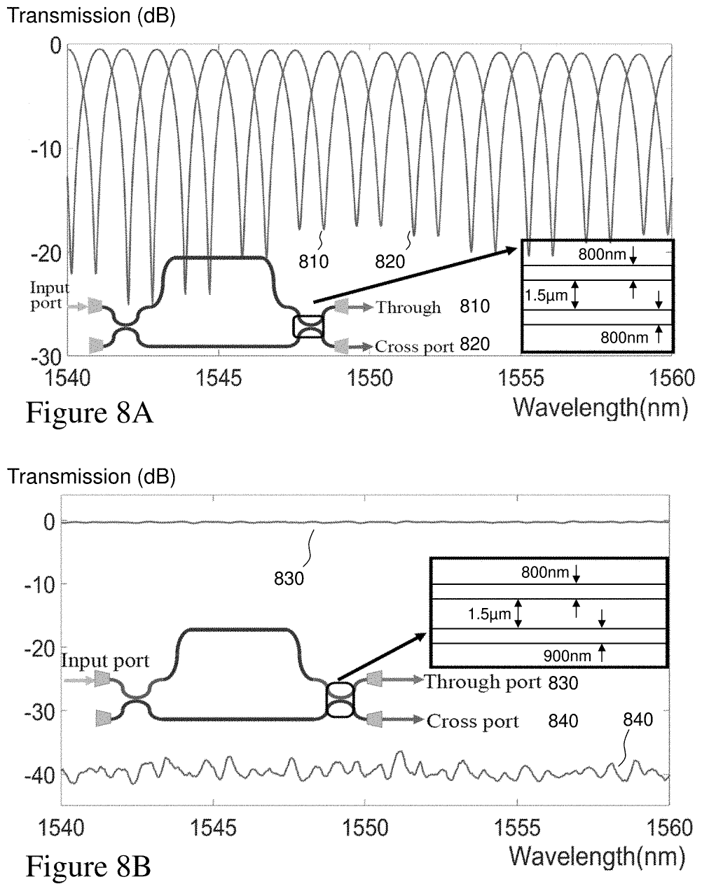

Within the exemplary embodiments presented here optical signals were coupled to the MZIs and AWGs through surface grating couplers (SGCs). The normalized transmission spectrums of the MZIs are depicted in FIG. 8A for the conventional MZI and FIG. 8B for the MZI with waveguide supercell (MZI-SC). In FIG. 8A the optical signals from the Through 810 and Cross Port 820 are depicted for the conventional MZI whilst the Through 830 and Cross Port 840 in FIG. 8B are for the MZI-SC design according to an embodiment of the invention. The result of the optical coupling within the directional couplers and phase imbalance variation with wavelength being clearly evident in the conventional MZI transfer characteristics for the cross and through ports. The conventional MZI having a periodicity with wavelength of approximately 1.9 nm. In contrast, little variation is evident in the MZI-SC which indicates that the waveguide supercell can effectively prevent parasitic coupling between adjacent waveguides.

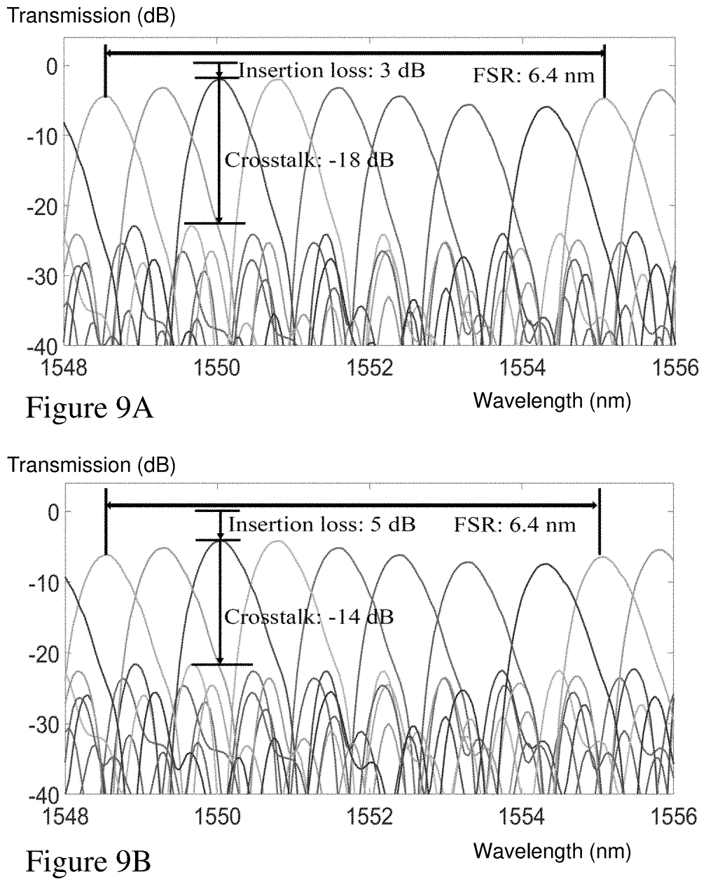

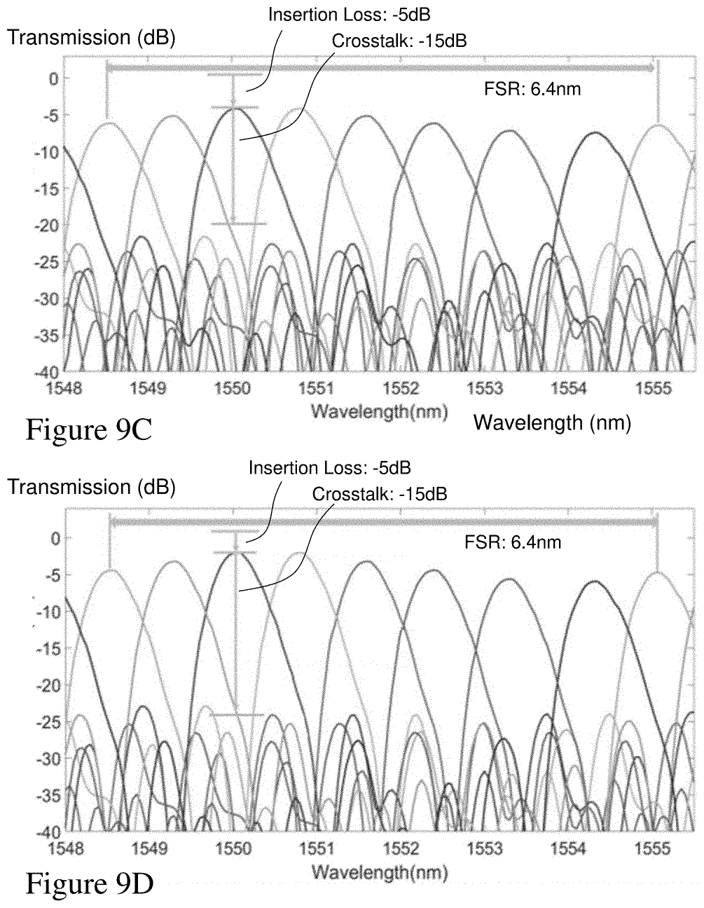

The corresponding transmission spectra for the 1×8 100 GHz AWGs of the AWG-SC design and convention design are depicted in FIGS. 9A to 9D respectively. At the nominal target center wavelength of 1550 nm, the insertion loss is approximately 3 dB for the AWG-SCs and around 5 dB for the conventional AWGs. This insertion loss consisting of the bending loss in waveguides, the waveguide scattering loss, and the coupling loss between the star couplers and the arrayed waveguides. The measured waveguide propagation loss was about 1.5 dB/cm which arises primarily through scattering losses caused by the roughness of the sidewalls, which could be reduced by optimizing the reactive ion etching process employed for the dry etch, eliminating cracks, etc. Other fabrication process steps such as post annealing after upper cladding deposition etc. may also be employed within other embodiments of the invention.

The channel crosstalk across all channels for the AWG-SC was approximately −18 dB, as shown in FIG. 9A, for one AWG-SC and approximately −20 dB, as shown in FIG. 9C, for another AWG-SC. The channel crosstalk for the conventional AWG was approximately −14 dB, as shown in FIG. 9B, for one AWG and approximately −15 dB, as shown in FIG. 9D, for another AWG. The free spectral range of the AWG was 6.4 nm.

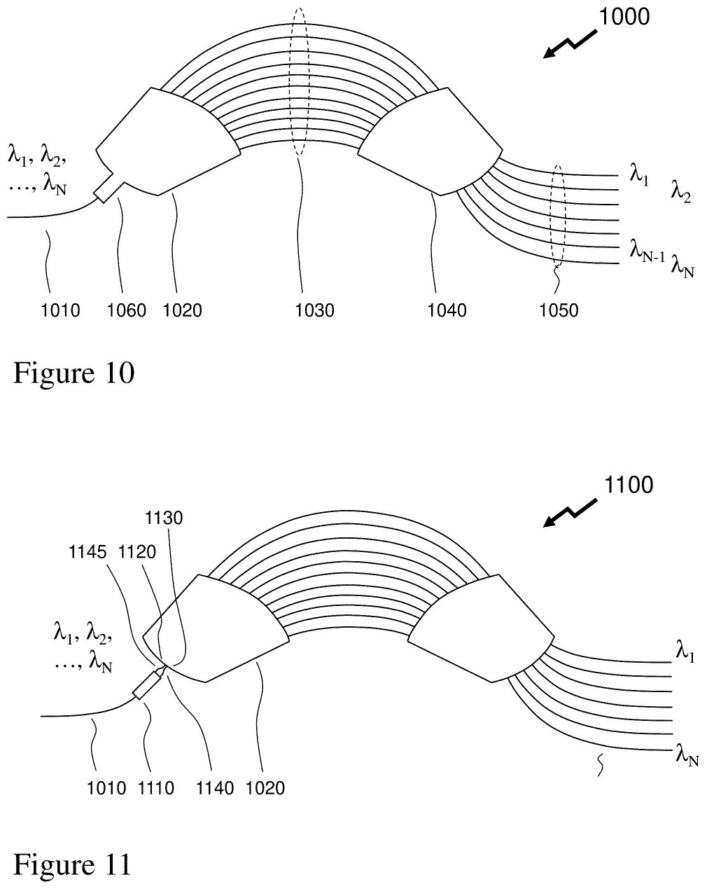

Now referring to FIG. 10 depicts a schematic 1000 of an AWG-SC according to an embodiment of the invention exploiting a multimode interference (MMI) structure 1060 between the input channel waveguide 1010 and the input free propagation region (FPR) 1020. The AWG-SC further comprising the array of waveguides 1030 which start at the other end of the first FPR 1020 to the input waveguide 1010 and end at the second FPR 1040. The multiple optical signals from the array of waveguides 1030 coupled to the second FPR 1040 combine according to accumulated phase shifts to a waveguide of an output array 1050 at the other end of the second FPR 1040. The MMI 1060 may within embodiments of the invention act as a mode converter wherein the optical mode geometry at the transition between the MMI 1060 and the first FPR 1020 is different to that within the input waveguide 1010. For example, the optical mode may be wider and allowing this mode conversion with the requirement to form a waveguide taper at the transition between the input waveguide 1010 and the first FPR 1020. For example, such a mode conversion can be employed to adjust the passband characteristic of the AWG resulting in increased bandwidth performance through providing a “flat-top” response as known in the art rather than a Gaussian passband response.

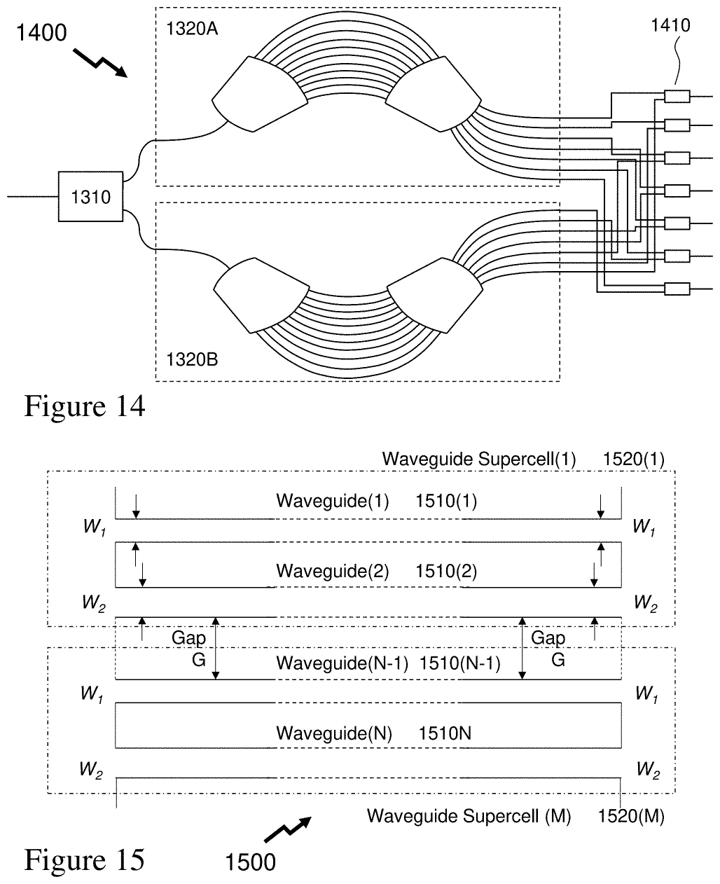

Referring to FIG. 13 there is depicted a schematic 1300 wherein a pair of AWG-SCs 1320A and 1320B are coupled to a polarization splitter 1310 such that each of the pair of AWG-SCs 1320A and 1320B acts upon a different polarization in order to provide a polarization independent WDM DMUX. Alternatively, as depicted in FIG. 14 in schematic 1400 the polarization splitter 1310 and the pair of AWG-SCs 1320A and 1320B are combined with an array of polarization combiners 1410.

Accordingly, each polarization combiner 1410 receives optical signals having a TE polarisation at the wavelength of a predetermined output waveguide of an AWG-SC, e.g. AWG-SC 1320A, and other optical signals having a TM polarisation at the wavelength of the same predetermined output waveguide of the other AWG-SC, AWG-SC 1320B. In this scenario the upper output of polarization splitter 1310 couples TE polarisation signals to the upper AWG-SC, AWG-SC 1320A, and TM polarisation signals to the lower AWG-SC, AWG-SC 1320B. It would be evident to one of skill in the art that alternatively the TE polarisation may be coupled to the lower AWG-SC, AWG-SC 1320B, and the TM polarisation to the upper AWG-SC, AW-SC 1320A. Whilst within schematic 1400 the interconnection between the pair of AWG-SCs 1320A and 1320B and the array of polarization combiners 1410 has been depicted with straight transitions (e.g. as might be implemented with right angled mirrors) it would be evident that these transitions may be implemented with circular waveguide sections or waveguides having polynomials to define position versus length such that they are continuous, for example, in their first and second derivatives.

Alternatively, as depicted in FIG. 11 with schematic 1100, a polarization independent AWG based DMUX may employ an MMI 1110 which may provide polarization splitting such that the launch position for TE is at a first position 1120 at the transition to the first FPR 1020 whilst the launch position for TM is at a second position 1130. This adjustment in launch position being achieved through coupling the input MMI 1110 to the first FPR 1020 via a pair of stub waveguides, first and second stub waveguides 1140 and 1145 respectively. As depicted first stub waveguide 1140 couples the TM signals to the second position 1130 upon the first FPR 1020 whilst the second stub waveguide 1145 couples the TE signals to the first position 1120 upon the first FPR 1020. Accordingly, each stub waveguide acts upon a different polarization and adjusts the launch mode profile into the first FPR 1020 from that at the end of the MMI 1110. Optionally, within other embodiments of the invention the MMI may be implemented with other photonic circuit polarization splitter designs including, but not limited to a plasmon based polarization splitter, an asymmetric directional coupler, a 2×2 MMI, and an MZI employing MMIs. Optionally, within other embodiments of the invention the pair of stub waveguides may be ultra-short or zero length such that the output of the MMI 1110 is essentially directly coupled to the input FPR 1020. It would be evident to one skilled in the art that the positions 1120 and 1130 for the TE and TM polarisations may be reversed. The offset launch positions of the TE and TM polarisations allows for compensation of the refractive index differences for TE and TM polarisations arising from the rectangular birefringent waveguides so that the wavelength responses of the TE and TM polarisations are aligned within the overall device.

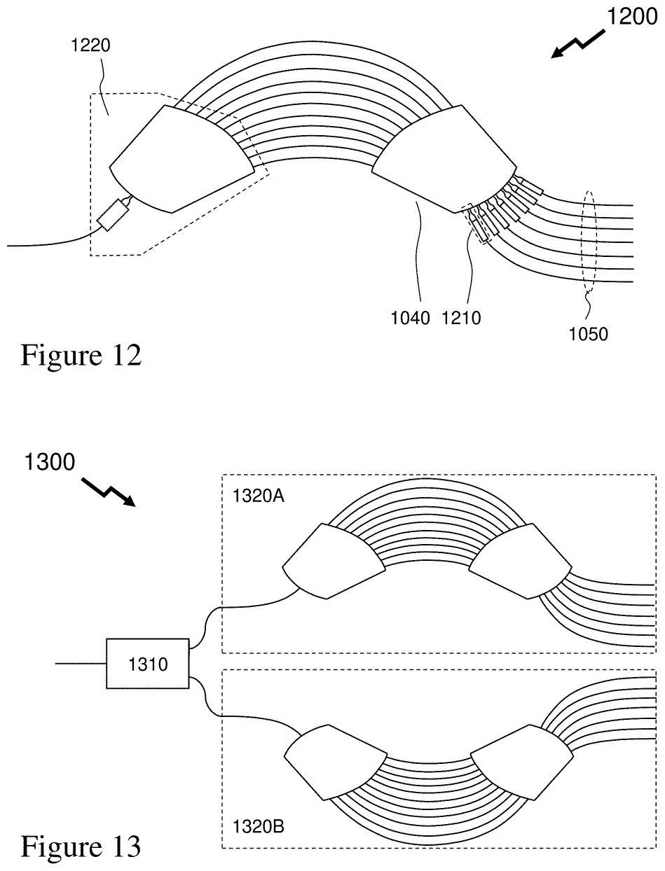

Further, as depicted in FIG. 12 with schematic 1200 additional output MMI 1210 structures may be implemented such that polarization dependent offsets for specific wavelengths are compensated for by their launching into the same output MMI and being combined at the other end to the appropriate output waveguide of the array of output waveguides. Accordingly, as depicted within schematic 1200 the AWG employs an input section 1220 comprising the input FPR and an MMI polarization beam splitter with stub waveguides such as described and depicted above in respect to FIG. 11. However, at the output FPR 1040 the transition from the output FPR 1040 to the output waveguides 1050 now includes an output MMI 1210. Each output MMI 1210 comprising a pair of stub waveguides each coupled at one end to the output FPR 1040 and at their other end to an MMI. Accordingly, each output MMI 1210 acts similarly to MMI 1110 in FIG. 11 but now in reverse such that TE and TM polarisations are coupled to the pair of stub waveguides and then these polarizations are combined by the MMI onto the respective output waveguide of the array of output waveguides 1050.

Optionally, within other embodiments of the invention the MMI may be implemented with other photonic circuit polarization combiner designs including, but not limited to a plasmon based polarization combiner, an asymmetric directional coupler, a 2×2 MMI, and an MZI employing MMIs. Optionally, within other embodiments of the invention the pair of stub waveguides may be ultra-short or zero length such that the output of the MMI 1110 is essentially directly coupled to the input FPR 1020. It would be evident to one skilled in the art that the positions for the TE and TM polarisations at the output of the output FPR 1040 may be TE to the left stub waveguide of the pair of stub waveguides and TM to right stub waveguide of the pair of stub waveguides or reversed.

Accordingly, AWG-SCs such as depicted in FIGS. 11 and 12 may provide for polarization compensation where the AWG-SC is not polarization independent, such as for example arising from inherent material birefringence of the waveguide material(s) or geometrically induced birefringence from the geometry of the waveguide(s) within the AWG-SC.

Within embodiments of the invention the polarization splitter may be a fiber optic device coupled to the pair of AWG-SCs or it may a monolithically integrated polarization splitter such as a plasmon based polarization splitter, an asymmetric directional coupler, a 2×2 MMI, and an MZI employing MMIs, for example. In a similar manner each polarization combiners 1410 may be a fiber optic device coupled to the pair of AWG-SCs or it may a monolithically integrated polarization combiner such as a plasmon based polarization combiner, an asymmetric directional coupler, a 2×2 MMI, and an MZI employing MMIs, for example.

Now referring to FIG. 15 there is depicted a schematic 1500 of an exemplary configuration of waveguides within an AWG-SC according to an embodiment of the invention. Within the preceding descriptions in respect of embodiments of the invention it may have been presumed or assumed that the waveguides within an AWG-SC according to an embodiment of the invention are configured as depicted in schematic 1500. Accordingly, there are depicted a series of waveguide supercells (WG-SC), WG-SC(1) 1520(1) to WG-SC(M) 1520(M) each comprising a pair of waveguides of widths W₁ and W₂. Accordingly, WG-SC(1) 1520(1) comprises Waveguide(1) 1510(1) of width W₁ and Waveguide(2) 1520(2) of width W₂ and WG-SC(M) 1520(M) comprises Waveguide(N−1) 1510(N−1) of width W₁ and Waveguide(N) 1520(N) of width W₂. Accordingly, each waveguide from the first free propagating region (FPR) to the second FPR is of constant width. As noted below each waveguide supercell may comprise R waveguides where R≥2 and R is an integer.

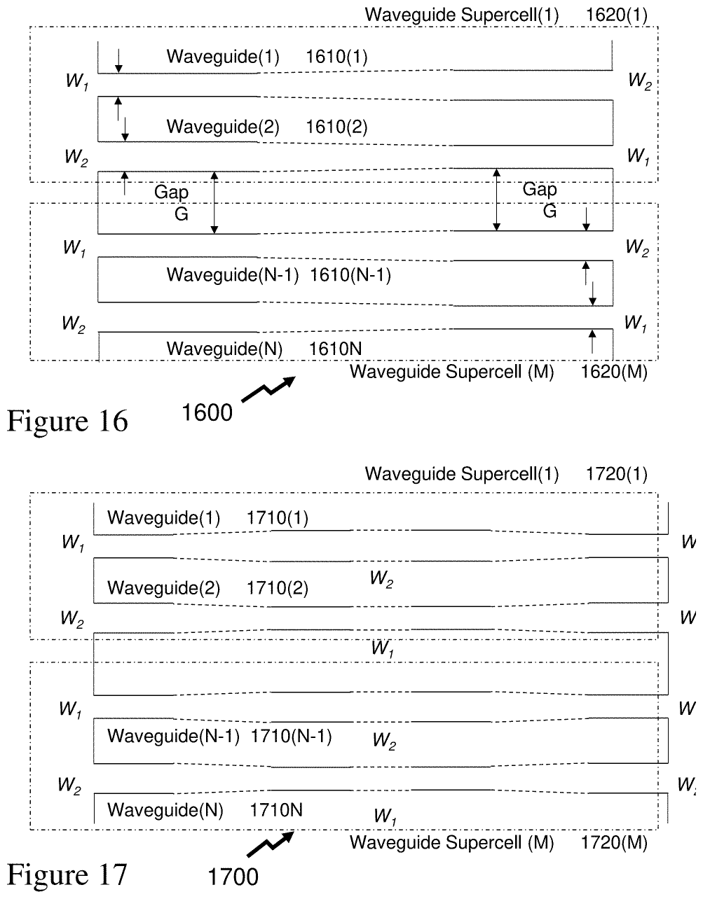

However, in some instances to reduce sensitivity of the resulting AWG-SC to manufacturing tolerances, e.g. photolithographic definition of waveguide widths, etching, film thicknesses, film indices etc. it may be beneficial to replace the waveguide set within an AWG-SC or other waveguide device exploiting WG-SCs with the exemplary configuration of waveguides as depicted in schematic 1600 in FIG. 16 according to an embodiment of the invention.

Accordingly, within schematic 1600 there are depicted a series of waveguide supercells (WG-SC), WG-SC(1) 1620(1) to WG-SC(M) 1620(M) each comprising a pair of waveguides. Accordingly, WG-SC(1) 1620(1) comprises Waveguide(1) 1610(1) and Waveguide(2) 1620(2) whilst WG-SC(M) 1620(M) comprises Waveguide(N−1) 1610(N−1) and Waveguide(N) 1620(N). However, each waveguide now varies along its length as depicted in FIG. 16 and represented in Table 1 below.

TABLE 1
Waveguide Geometries at First and Second Free Propagation
Zones for Configuration Depicted in FIG. 16

| Waveguide | | Width at First Free | Width at First Free |
|---|---|---|---|
| Supercell | Waveguide | Propagation Region | Propagation Region |
| WG-SC(1) | Waveguide(1) | W₁ | W₂ |
| 1620(1) | 1610(1) | | |
| | Waveguide(1) | W₂ | W₁ |
| | 1610(2) | | |
| . . . | . . . | . . . | . . . |
| WG-SC(M) | Waveguide(1) | W₁ | W₂ |
| 1620(M) | 1610(N-1) | | |
| | Waveguide(1) | W₂ | W₁ |
| | 1610(N) | | |

Accordingly, each waveguide varies through a taper from an initial width at the first free propagating region (FPR) to another width at the second FPR. This taper may be of a relatively short length disposed at a point along each waveguide or it may be a long taper such that the taper occurs over a portion of the curved/bent waveguide regions between the first and second FPRs. Within the limit the taper may be the whole waveguide from first FPR to second FPR.

As noted below each waveguide supercell may comprise R waveguides where R≥2 and R is an integer. In this each Waveguide(S), 1≤S≤R, may taper from an initial width W_{S} to a final width W_{T}, where S=1, 2, . . . , R and T=R, 1, . . . , R−1. It would be evident that other combinations would be possible without departing from the scope of the invention.

However, within other embodiments of the invention a pair of waveguide tapers may be employed such as depicted in FIG. 17 referring to schematic 1700 of an exemplary configuration of waveguides within an AWG-SC according to an embodiment of the invention. Accordingly, within schematic 1700 there are depicted a series of waveguide supercells (WG-SC), WG-SC(1) 1720(1) to WG-SC(M) 1720(M) each comprising a pair of waveguides. Accordingly, WG-SC(1) 1720(1) comprises Waveguide(1) 1710(1) and Waveguide(2) 1720(2) whilst WG-SC(M) 1720(M) comprises Waveguide(N−1) 1710(N−1) and Waveguide(N) 1720(N). However, each waveguide now varies along its length as depicted in FIG. 17 and represented in Table 2 below.

TABLE 2
Waveguide Geometries at First and Second Free Propagation
Zones for Configuration Depicted in FIG. 17

| | | Width at | | Width at |
|---|---|---|---|---|
| | | First Free | Width | Second Free |
| Waveguide | | Propagation | between | Propagation |
| Supercell | Waveguide | Region | Tapers | Region |
| WG-SC(1) | Waveguide(1) | W₁ | W₂ | W₁ |
| 1720(1) | 1710(1) | | | |
| | Waveguide(1) | W₂ | W₁ | W₂ |
| | 1710(2) | | | |
| . . . | . . . | . . . | . . . | . . . |
| WG-SC(M) | Waveguide(1) | W₁ | W₂ | W₁ |
| 1720(M) | 1710(N-1) | | | |
| | Waveguide(1) | W₂ | W₁ | W₂ |
| | 1710(N) | | | |

As noted below each waveguide supercell may comprise R waveguides where R≥2 and R is an integer. In this each Waveguide(S), 1≤S≤R, may taper from an initial width W_{S} to an intermediate width W_{T} before transitioning back to its final width W_{S}, where S=1, 2, . . . , R and T=R, 1, . . . , R−1. It would be evident that other combinations would be possible without departing from the scope of the invention.

It would be evident that whilst FIGS. 16 and 17 depict single and dual tapers that embodiments of the invention may support three or more tapers or that the waveguides may be “corrugated” where the number of tapers becomes large. It would be evident that the sequence of waveguides where there are 3 or more within each WG-SC may be varied such as described below.

Channel crosstalk within the AWG depends upon the resolution of the recombined field distribution at the output channels, which is a function of the number of arrayed waveguides. Within the designs employed this was limited to 40. Increasing the number of arrayed waveguides results in a more reliable recreation of the field distribution of the input channel. However, it also increases sensitivity to phase errors caused by variation in the fabrication process and increases the device footprint. Within the prior art exploiting a SOI platform it has been suggested that the optimum number of arrayed waveguides should be 3.5 times the number of output channels, which for an 8 channel AWG-SC would be 28. The suppressed neighborhood waveguide crosstalk within the waveguide supercells improves the recombined field distribution at the output channels which significantly improves the channel crosstalk performance and also allows for a denser waveguide array of the AWG-SC. The denser waveguide array incidentally also reduces the AWG-SC device footprint, which helps to minimize the portion of the insertion loss which is tied to the propagation losses that result from the arrayed waveguides.

The channel crosstalk of an AWG is a function of the overall phase noise for all waveguides within the array of the AWG. As the superlattice concept allows the packing density of these waveguides to be increased without increasing waveguide crosstalk, the overall footprint reduction reduces the overall phase noise within the array of waveguides. Accordingly, the waveguide superlattices improve the channel crosstalk performance for an AWG.

Within previous work by the inventors a 1×8 AWG on the same SiO₂—Si₃N₄—SiO₂ platform showing similar performance required a 10 μm gap between the 800 nm waveguides within the arrayed waveguides, rather than the 1.5 μm separation of the AWG-SC according to an embodiment of the invention, with a die footprint of 4.7 mm×1.4 mm. Accordingly, an AWG-SC according to an embodiment of the invention as presented above exploits approximately 40% of the footprint of the conventional prior art AWG.

Within the embodiments of the invention described and depicted above a waveguide supercell has been described and depicted as comprising a pair of waveguides which are then replicated within the array of waveguides within the AWG. However, it would be evident to one of skill in the art that within other embodiments of the invention other counts for the number of waveguides within a waveguide supercell may be employed, such as 3, 4, 5 etc. Where three waveguides are employed with widths w₁, w₂, and w₃ where w₁<w₂<w₃ then these may be employed in one of several sequences w₁, w₂, w₃ (set 1), w₁, w₃, w₂ (set 2), w₂, w₁, w₃ (set 3), w₂, w₃, w₁ (set 4), w₃, w₂, w₁ (set 5), and w₃, w₁, w₂ (set 6). Within an embodiment of the invention a specific sequence may be repeated within the waveguide supercell. Within another embodiment of the invention the waveguide supercell may exploit a repeating sequence of a subset of the potential subsets, for example three subsets of the six potential subsets when using three different waveguide widths (e.g. a repeating sequence of sets 1, 2, 3 or repeating sequence of sets 1, 4, 6 for example). Within another embodiment of the invention the waveguide supercell may exploit a randomized sequence of a subset of the potential subsets, for example three subsets of the six potential subsets when using three different waveguide widths (e.g. a pseudo-randomized sequence of sets 1, 2, 3 or pseudo-randomized sequence of sets 1, 4, 6 for example).

Within other embodiments of the invention the variations in effective index of the waveguides within the waveguide supercell may be achieved using one or other techniques according to the waveguide system being employed. Within embodiments of the invention multiple lithography and deposition steps may be exploited to provide waveguides with varying thickness discretely or in combination with width variations. Within other embodiments of the invention multiple lithography and deposition steps may be exploited to provide waveguides with varying composition either discretely with constant width and thickness cross-sections or with variations in width and/or thickness of the cross-section. For example, these techniques may be exploited with waveguides exploiting SiO₂—Si₃N₄—SiO₂; SiO₂—SiO_{X}N_{Y}—SiO₂; SiO₂—Ge:SiO₂—SiO₂; Si—SiO₂; polymeric materials, InGaAsP, InP, GaAs, III-V materials, II-VI materials, Si, and SiGe material systems or waveguides exploiting buried waveguides, rib waveguides, ridge or wire waveguides, strip-loaded waveguides, slot waveguides, ARROW waveguides, photonic crystal waveguides, suspended waveguides, alternating layer stack geometries, and augmented waveguides for example.

Within other embodiments of the invention different dopant cross-sections, i.e. film thickness and/or width, may be employed when forming diffused waveguides for example. Within other embodiments of the invention different dopant profiles, for example, from ion implantation rather than ion diffusion, may be employed to generate waveguides of different effective indices discretely or in combination with other techniques.

Within other embodiments of the invention rather than employing constant width waveguides of different widths within the array of waveguides the waveguides may have different widths, but these widths may vary along the length of the waveguides within the array of waveguides. Such variations may be periodic or aperiodic. The width variation(s) may be only applied to a subset of the waveguides within a waveguide supercell. The width variation(s) may be applied over only a portion of the length of the waveguide between the first FPR and the second FPR.

Within embodiments of the invention described above a gap between adjacent waveguides of adjacent waveguide supercells (1.5 μm) is the same as that between the pair of waveguides (1.5 μm) within each waveguide supercell. Accordingly, within embodiments of the invention the gap between adjacent waveguides of adjacent waveguide supercells may be the same as that between any pair of waveguides within each waveguide supercell. Within other embodiments of the invention the gap between adjacent waveguides of adjacent waveguide supercells may be different to that between adjacent pairs of waveguides within each waveguide supercell.

Within embodiments of the invention the waveguides may be designed to have a predetermined birefringence between TE and TM polarisations. This may be a zero birefringence in some embodiments of the invention, constrained with a predetermined range within other embodiments of the invention or unconstrained within other embodiments of the invention.

Within embodiments of the invention the photonic waveguide devices exploiting waveguide supercells may be designed to be athermal. Within other embodiments of the invention one or more methods of temperature compensation may be employed such as active heaters, coolers, etc. or tunable optical launch to the first FPR for example. Within other embodiments of the invention the design of the photonic device may be such that temperature drifts within the device are accommodated within the overall circuit design and/or performance specification.

Within embodiments of the invention described above the AWGs employing waveguide supercells are transmissive with two FPRs coupled at either end of the array of waveguides. Within other embodiments of the invention the array of waveguides may terminate with reflectors such that the AWG is folded back onto itself such that the first and second FPR are the same FPR. These reflectors may be wide Bragg grating based reflectors (over an operating wavelength range of the AWG), thin film filters (over an operating wavelength range of the AWG), mirror facets on the waveguides, a mirrored facet of the die within which the AWG is formed, or a facet of the die within which the AWG coated with a coating having a high reflectivity over the operating wavelength range of the AWG.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A waveguide device comprising:
an input waveguide coupled to a first end of a first free propagation region (FPR);
an array of waveguide supercells each comprising a plurality of waveguides, each waveguide of the plurality of waveguides having a different target effective refractive index to each other waveguide within the plurality of waveguides, coupled at a first end to a first predetermined position on a second distal end of the first FPR and coupled at a second distal end to a second predetermined position of a first end of a second FPR; and
a plurality of output waveguides, each output waveguide of the plurality of output waveguides coupled to a third predetermined position on a second distal end of the second FPR.

2. The waveguide device according to claim 1, wherein
channel crosstalk performance of the waveguide device is improved relative to another waveguide device employing another first FPR, another second FPR and a number of waveguides all of equal width where the number of waveguides within the another waveguide device is the same as that within the waveguide device.

3. The waveguide device according to claim 1, wherein
each waveguide of the plurality of waveguides within a waveguide supercell of the plurality of supercells having a target refractive index is offset from the waveguide of the plurality of waveguide supercells within an adjacent waveguide supercell of the plurality of waveguide supercells with the same target refractive index by a predetermined physical length established in dependence upon the target refractive index of the waveguide of the plurality of waveguides.

4. (canceled)

5. The waveguide device according to claim 1, wherein
one of:
an order of the plurality of waveguides within each waveguide supercell of the array of waveguide supercells is constant;
an order of the plurality of waveguides within each waveguide supercell of the array of waveguide supercells is different; and
an order of the plurality of waveguides within each waveguide supercell of the array of waveguide supercells is different and established pseudo-randomly.

6-7. (canceled)

8. The waveguide device according to claim 1, wherein
the array of waveguide supercells comprises a plurality of subsets;
the plurality of waveguides within each waveguide supercell forming part of a subset of the plurality of subsets are in a predetermined order; and
the predetermined order for each subset of the plurality of subsets is different to the other subsets of the plurality of subsets.

9. The waveguide device according to claim 1, wherein
one of:
a first gap between adjacent waveguides of adjacent waveguide supercells of the array of waveguide supercells is the same as a second gap between any pair of waveguides of the plurality of waveguides within each waveguide supercell of the array of waveguide supercells; and
a first gap between adjacent waveguides of adjacent waveguide supercells of the array of waveguide supercells is different to a second gap between any pair of waveguides of the plurality of waveguides within each waveguide supercell of the array of waveguide supercells.

10. (canceled)

11. The waveguide device according to claim 1, wherein
one of:
a gap between adjacent waveguides within the plurality of waveguides within a waveguide supercell of the array of waveguide supercells is constant within the waveguide supercell of the array of waveguide supercells; and
a gap between adjacent waveguides within the plurality of waveguides within a waveguide supercell of the array of waveguide supercells varies in dependence upon which adjacent waveguides within the plurality of waveguides it relates to.

12. (canceled)

13. The waveguide device according to claim 1, wherein
each waveguide of the plurality of waveguides comprises:
a first portion coupled to the first predetermined position on the second distal end of the first FPR which tapers from a first width at the second distal end of the first FPR to a second width;
a second portion coupled to the second predetermined position of the first end of the second FPR which tapers from a third width at the first end of the second width; and
a third portion disposed between the first portion and the second portion having the second width.

14. The waveguide device according to claim 1, wherein
each waveguide of the plurality of waveguides comprises:
a first portion coupled to the first predetermined position on the second distal end of the first FPR which tapers from a first width at the second distal end of the first FPR to a second width;
a second portion coupled to the second predetermined position of the first end of the second FPR which tapers from a third width at the first end of a fourth width; and
a third portion disposed between the first portion and the second portion having the second width at a first end coupled to the first portion and the fourth width at a second distal end coupled to the second portion.

15. The waveguide device according to claim 1, wherein
one of:
a width of each waveguide of a subset of the plurality of waveguides within each waveguide supercell of the array of waveguide supercells varies periodically over a predetermined portion of its length; and
a width of each waveguide of a subset of the plurality of waveguides within each waveguide supercell of the array of waveguide supercells varies aperiodically over a predetermined portion of its length.

16. (canceled)

17. The waveguide device according to claim 1, wherein
the input waveguide coupled to the first end of the first FPR is one of a plurality of input waveguides; and
an end of each input waveguide coupled to the first end of the first FPR is disposed at a predetermined position on the first end of the first FPR.

18. The waveguide device according to claim 1, wherein
the first FPR and the second FPR are the same FPR; and
each waveguide of the plurality of waveguides within each waveguide supercell of the array of waveguide supercells includes a reflector.

19. The waveguide device according to claim 18, wherein
each reflector is one of:
a reflective Bragg grating reflecting over an operating wavelength range of the AWG;
a thin film filter reflecting over the operating wavelength range of the AWG;
a mirror formed upon a facet of the waveguide; and
a facet of a die of which the waveguide device forms part coated with a coating having a high reflectivity over the operating wavelength range of the AWG.

20. The waveguide device according to claim 1, further comprising
a multimode interferometer disposed between the input waveguide and the first end of the first FPR.

21. The waveguide device according to claim 1, further comprising
a multimode interferometer disposed between the input waveguide and the first end of the first FPR; wherein
first optical signals within the input waveguide having a first polarization are at first predetermined position at the transition from the MMI to the first FPR;
second optical signals within the input waveguide having a second polarization are at second predetermined position at the transition from the MMI to the first FPR; and
first optical signals at a predetermined wavelength and second optical signals at the predetermined wavelength are coupled to the same output waveguide of the plurality of output waveguides.

22. The waveguide device according to claim 1, further comprising
a multimode interferometer (MMI) disposed between the input waveguide and the first end of the first FPR having an input end coupled to the input waveguide and an output end comprising a pair of stub waveguides each of a predetermined length coupled to the first FPR; wherein
first optical signals within the input waveguide having a first polarization are coupled to a first stub waveguide of the pair of stub waveguides which is coupled to the first FPR at a first predetermined position;
second optical signals within the input waveguide having a second polarization are coupled to a second stub waveguide of the pair of stub waveguides which is coupled to the first FPR at a second predetermined position; and
first optical signals at a predetermined wavelength and second optical signals at the predetermined wavelength are coupled to the same output waveguide of the plurality of output waveguides.

23. The waveguide device according to claim 1, further comprising:
a plurality of multimode interferometers (MMIs), each output MMI disposed between a predetermined output waveguide of the plurality of output waveguides and the second end of the second FPR having an output end coupled to the output waveguide and an input end comprising a pair of stub waveguides each of a predetermined length coupled to the second FPR; wherein
first optical signals within the second FPR having a first polarization are coupled to a first stub waveguide of the pair of stub waveguides and therein to the output waveguide;
second optical signals within the second FPR having a second polarization are coupled to a second stub waveguide of the pair of stub waveguides and therein to the output waveguide.

24. The waveguide device according to claim 1, further comprising
an input multimode interferometer (MMI) disposed between the input waveguide and the first end of the first FPR having an input end coupled to the input waveguide and an output end comprising a pair of stub waveguides each of a predetermined length coupled to the first FPR; and
a plurality of output MMIs, each output MMI disposed between a predetermined output waveguide of the plurality of output waveguides and the second end of the second FPR having an output end coupled to the output waveguide and an input end comprising a pair of stub waveguides coupled to the second FPR; wherein
first optical signals within the input waveguide having a first polarization are coupled to a first stub waveguide of the pair of stub waveguides of the input MMI which is coupled to the first FPR at a first predetermined position;
second optical signals within the input waveguide having a second polarization are coupled to a second stub waveguide of the pair of stub waveguides of the input MMI which is coupled to the first FPR at a second predetermined position;
the first optical signals within the second FPR having the first polarization are coupled to a first stub waveguide of the pair of stub waveguides and therein to the output waveguide;
the second optical signals within the second FPR having a second polarization are coupled to a second stub waveguide of the pair of stub waveguides and therein to the output waveguide.

25. The waveguide device according to claim 1, further comprising:
a polarization splitter having a first output for optical signals having a first polarization and a second output for optical signals having a second polarization; and
another waveguide device comprising:
another input waveguide coupled to a first end of another first free propagation region (FPR);
another array of waveguide supercells each comprising a plurality of waveguides, each waveguide of the plurality of waveguides having a different target effective refractive index to each other waveguide within the plurality of waveguides, coupled at a first end to a first predetermined position on a second distal end of the another first FPR and coupled at a second distal end to a second predetermined position of a first end of another second FPR; and
another plurality of output waveguides, each output waveguide of the plurality of output waveguides coupled to a third predetermined position on a second distal end of the another second FPR; wherein
the first output of the polarization splitter is coupled to the input waveguide; and
the second output of the polarization splitter is coupled to the other input waveguide.

26. The waveguide device according to claim 24, further comprising:
a plurality of polarization combiners, each polarisation combiner comprising a first combiner input for receiving optical signals having the first polarization, a second combiner input for receiving optical signals having the second polarization and a combiner output; wherein
the first combiner input for a predetermined polarization combiner of the plurality of polarization combiners is coupled to a predetermined output waveguide of the plurality of output waveguides of the waveguide device;
the second combiner input for a predetermined polarization combiner of the plurality of polarization combiners is coupled to a predetermined another output waveguide of the other plurality of outputs of the other waveguide device; and
the predetermined output waveguide of the plurality of output waveguides of the waveguide device and predetermined another output waveguide of the other plurality of outputs of the other waveguide device each have optical signals within a predetermined wavelength range.

27. A method of improving channel crosstalk performance of an array waveguide grating (AWG) device comprising:
providing an input waveguide coupled to a first end of a first free propagation region (FPR);
providing an array of waveguide supercells each comprising a plurality of waveguides, each waveguide of the plurality of waveguides having a different target effective refractive index to each other waveguide within the plurality of waveguides, coupled at a first end to a first predetermined position on a second distal end of the first FPR and coupled at a second distal end to a second predetermined position of a first end of a second FPR; and
providing a plurality of output waveguides, each output waveguide of the plurality of output waveguides coupled to a third predetermined position on a second distal end of the second FPR.

28. The method according to claim 27, wherein
providing the array of waveguide supercells improves the channel crosstalk performance of the waveguide device relative to another AWG employing another first FPR, another second FPR and a number of waveguides all of equal width where the number of waveguides within the other AWG is the same as that within the AWG device.

29. The method according to claim 27, wherein
optical crosstalk between adjacent and non-adjacent waveguides within a waveguide supercell of the array of waveguide supercells is reduced relative to a similar design with waveguides of constant width; and
optical crosstalk between waveguides of equal width within adjacent waveguide supercells of the array of waveguide supercells is reduced relative to the similar design with waveguides of constant width.
